(19) United States
(12) Patent Application Publication
(10) Pub. No.: US 2024/0119058 A1
(43) Pub. Date: Apr. 11, 2024

(54) CONTEXTUAL COMPARISION ENGINE FOR HISTORICAL RECORD SEARCH AND REVIEW

(71) Applicant: Zoom Video Communications, Inc., San Jose, CA (US)

(72) Inventor: Shane Paul SPRINGER, Oregon City, OR (US)

(73) Assignee: Zoom Video Communications, Inc., San Jose, CA (US)

(21) Appl. No.: 17/962,592

(22) Filed: Oct. 10, 2022

(51) Int. Cl. G06F 16/2457

(52) U.S. Cl. CPC G06F 16/24578

(57) ABSTRACT

Systems and methods for providing a contextual comparison engine for historical record search and review is provided. In an aspect, a method may include receiving a search request including one or more properties and processing a plurality of historical records. The method may also include identifying a first historical record, wherein the first historical record has a first plurality of characteristics correlated with the one or more properties, identifying a second historical record, wherein the second historical record has a second plurality of characteristics correlated with at least one of the one or more properties or at least one characteristic of the first plurality of characteristics, and generating a correlation between the first plurality of and the second plurality of characteristics. A result including the correlation between the first historical record and the second historical record may be transmitted to a first client device.

### FIELD

The present application generally relates to videoconferences and more particularly relates to systems and methods for providing a contextual comparison engine for historical record search and review.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1, 2, and 3 show example systems for providing a contextual comparison engine for historical record search and review, according to an embodiment herein;

FIG. 4A illustrates a search request prompt, according to an embodiment herein;

FIG. 4B illustrates another search request prompt, according to an embodiment herein;

FIG. 5 illustrates example search results, according to an embodiment herein;

FIG. 6 illustrates an example contextual comparison view of a set of historical records, according to an embodiment herein;

FIG. 7 illustrates an example speech recognition system, according to an embodiment herein;

FIG. 8 illustrates a contextual comparison system, according to an embodiment herein;

FIG. 9 illustrates a prompt for previewing a section of a historical record, according to an embodiment herein;

FIG. 10 illustrates an exemplary method for providing a contextual comparison engine for historical record search and review, according to an embodiment herein; and

FIG. 11 shows an example computing device suitable for providing a contextual comparison engine for historical record search and review, according to this disclosure.

### DETAILED DESCRIPTION

Examples are described herein in the context of systems and methods for providing a contextual comparison engine for historical record search and review. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Video conference providers can enable people to interact with each other using their own computers (or “client devices”) with both video and audio in a variety of settings, such as in one-on-one conversations, group meetings, and webinars. While each of these types of settings can allow people to interact with each other, they can differ in character. For example, one-on-one conversations include only two people and may involve only a small amount of data being transmitted between the two client devices. Group meetings may involve a larger number of people all interacting with each other. In contrast, webinars typically involve a group of people that are attending to hear presentations from one or more presenters. Thus, in a webinar, interaction tends to be mostly one-way: from the presenter(s) to the audience. In addition, webinars can have very large numbers of participants, potentially numbering in the thousands or tens of thousands.

As the popularity of virtual meetings to replace conventional, in-person meetings, continues to rise, so too does the volume of recorded information available to people. Each time a virtual meeting is initiated, metadata associated with that virtual meeting may be generated. For example, when a virtual meeting is initiated, metadata including the date, time, a listing of the participants, and a topic of the virtual meeting may be generated. This information may be stored for recording purposes, in anticipation of being reviewed at a future date. However, the nominal information associated with the metadata, when recorded, may be of minimal use to someone trying to identify a virtual meeting of interest. For example, if a person is trying to find a name and phone number for a participant that he or she held a virtual meeting with, but cannot remember the date and time that the virtual meeting occurred, finding the relevant metadata may be time consuming or nearly impossible given the minimal keywords that will be associated with the metadata record. In other words, if the metadata record only contains the date and time of the virtual meeting, a topic of the virtual meeting (e.g., from the invite), a listing of the participants and their phone numbers, and a time duration of the virtual meeting, the searching person may not be able to readily identify the metadata record based on the little information he or she remembers.

However, it is common for a recording to be generated of a virtual meeting, such as by recording the audio streams, video streams, or both during a virtual meeting. Often, a recording of a virtual meeting may be generated in anticipation of future review and to be used as a resource in the future for individuals wanting to revisit the topics discussed during the virtual meeting. As everyday life increasingly involves and relies on virtual meetings, so too does the volume of recordings that are generated with the anticipation of future review. As recordings are generally only stored based on a title of the virtual meeting or based on the date and time of the virtual meeting, finding a recording of interest can be a cumbersome, time-consuming, or even impossible task. In other words, the problem is providing an effective and efficient way for an individual to find a recording of interest.

Presently, a common method of searching for a recording of interest is to use keyword searches. For example, based on a search request, a search is performed to identify records that include one or more of the keywords. If the keywords that the searcher used are not present in a record, then that record is not identified. As used herein, the term “searcher” includes a person who is performing or requesting the search. As illustrated in the above metadata record example, keyword searching can be inhibiting when a searcher is not sure what he or she is looking for or does not remember specific keywords needed to identify a particular record of interest.

To provide an efficient and effective search process for identifying relevant historical records, systems and methods for providing a contextual comparison engine are provided herein. Instead of simply relying on keywords provided by a searcher, a contextual comparison engine may gather additional information and use that additional information to identify historical records that may have particular relevancy to the search. In some embodiments, the contextual comparison engine may gather additional search elements based on a profile associated with the searcher. For example, if the searcher works in the finance department, then additional search elements relating to finance may be added to the search request.

The contextual comparison engine may also create contextual connections between historical records that may be saved and used during later searches. For example, if two historical records are identified by searchers as relevant under similar search requests, then a contextual connection may be generated between the two historical records such that the two historical records can be readily identified to a searcher when either one is identified as relevant.

To help the searcher to identify relevant historical records, relevancy scores may be generated for each of the historical records based on the search request. In some embodiments, the relevancy scores may identify a prominence of one or more participants in the historical record or a prominence of one or more keywords within the historical record. For example, if the searcher requests to find a historical record including a participant named Gus Anderson, then the search results may provider a count of the number of minutes Gus Anderson speaks in each of the identified historical records. This can provide additional context to the searcher as to the relevancy of the historical record to his or her search request.

It should be understood that as used herein, although the term “virtual meeting” is used, this term is meant to cover various forms of virtual communication, including video conferences, teleconferences, audio-only calls, static or dynamic digital document sharing (e.g., whiteboards or collaborative documents), electronic correspondence, and the like.

This illustrative example is given to introduce the reader to the general subject matter discussed herein and the disclosure is not limited to this example. The following sections describe various additional non-limiting examples and examples of systems and methods for providing a contextual comparison engine for historical record search and review.

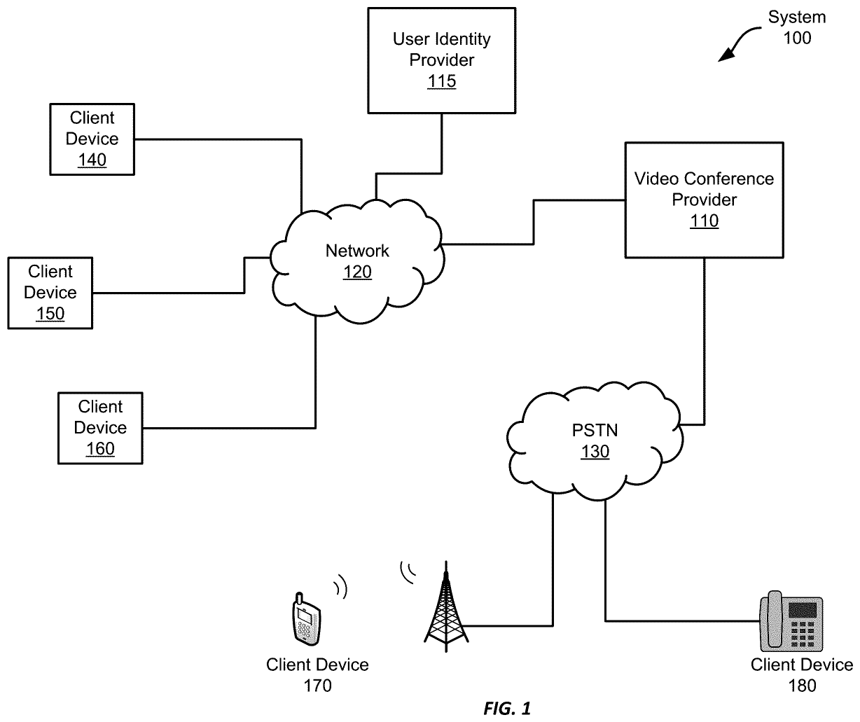

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the video conference provider 110 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

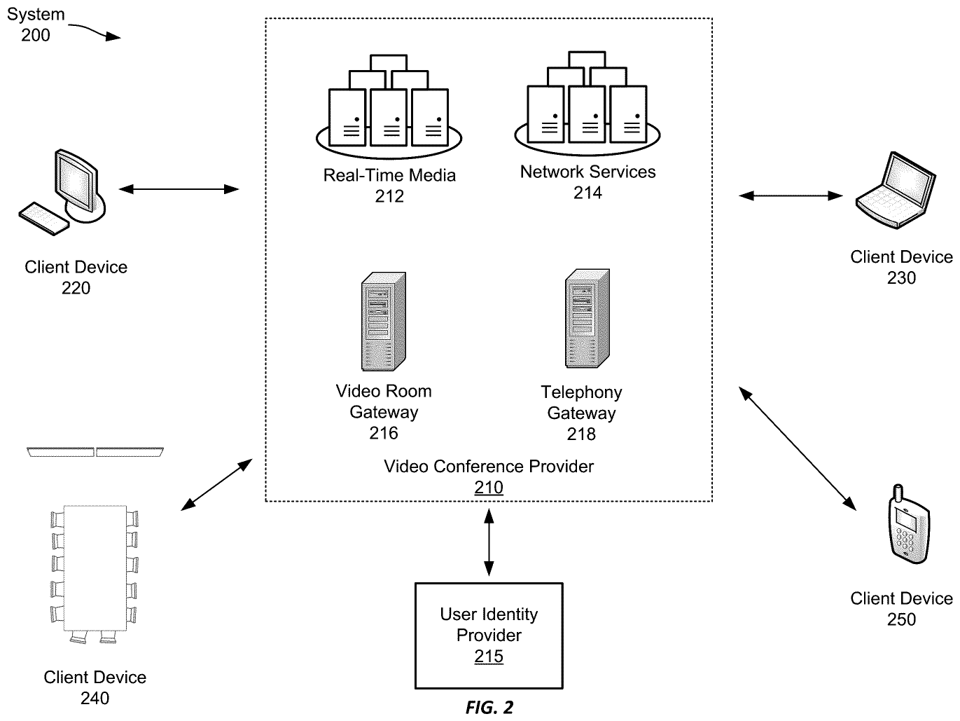

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can making conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different Examples of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

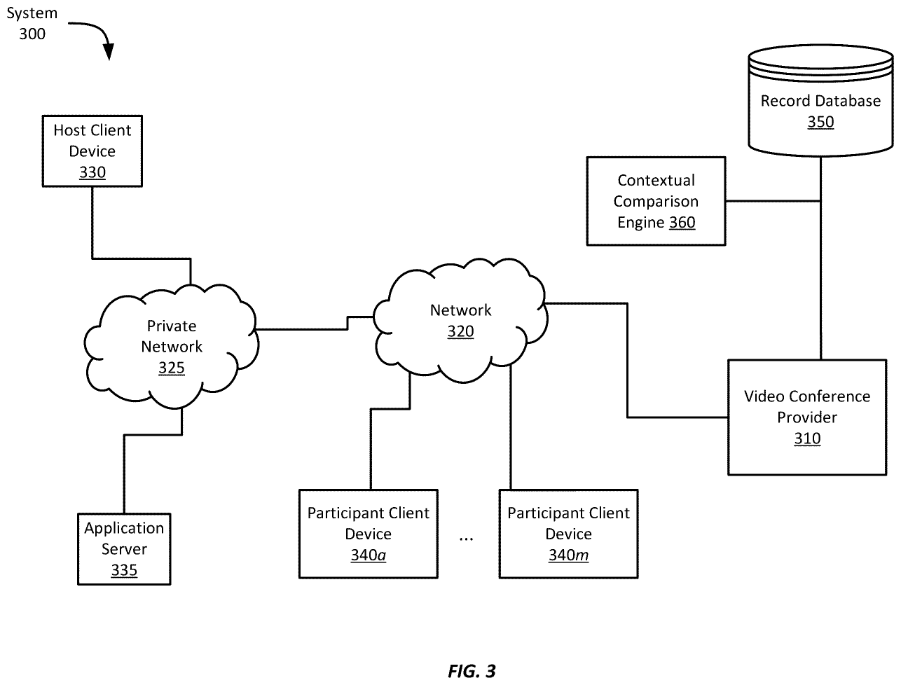

Referring now to FIG. 3, FIG. 3 shows an example system 300 for providing a contextual comparison engine for historical record search and review. In this example, a video conference provider 310 provides video conference services to multiple different client devices 330 and 340a-m, generally as described above with respect to FIGS. 1 and 2. In this example, the client devices 330 and 340a-m participate in a meeting hosted by the video conference provider 310. Client devices 340a-m connect to the video conference provider 310 over a public network 320, e.g., the internet; however, host client device 330 participates from within a private network 325, such as from their office at work. In addition to the host client device 330, an application server 335 is connected to the private network and makes various business applications available to the host client device 330. In different examples, these business applications may vary; however, in this example, the application server 335 provides applications to access business databases and files. To access these various resources, the host client device 330 has different client applications installed on it and may also have web applications accessible via a web browser, which may be stored as bookmarks in the web browser.

To start a meeting, the host client device 330 connects to the video conference provider 310 and begins a virtual meeting (“meeting”) at the video conference provider 310, such as by beginning a scheduled meeting, generally as described above with respect to FIGS. 1 and 2. The video conference provider 310 may create and manage the meeting as discussed above.

Once the virtual meeting is started, participants may be able to interact with other participants and see their respective names, such as in close proximity to other participants' video streams or in a list of participants visible in a graphical user interface (“GUI”). In some embodiments, the participants may only be able to see information, e.g., names or video feeds, from the host(s) of the meeting or certain select participants that will be engaged in discussions during the virtual meeting, such as panelists in a panel discussion. Still other limits may be imposed on the various participants, such as their ability to react to occurrences during the meeting, e.g., participants may be allowed to interact with their GUI to raise their hand to ask a question, but may not be allowed to provide any other feedback.

During the meeting, one of the participant client devices 340a-m or the host client device 330 may request to record the meeting. The request to record the meeting may be transmitted to the video conference provider 310. In some embodiments, the video conference provider 310 may prompt the non-requesting client devices with a notification that the meeting is going to be recorded. For example, if the host client device 330 request to record the meeting, the participant client devices 340a-m may receive a notification that the meeting is going to be recorded. Once the meeting request is accepted, the video conference provider 310 may record the audio and video streams from all of the client devices, 340a-m and 330, until the recording is terminated or the meeting is ended.

In some embodiments, the virtual meeting may not be recorded. In such cases, a historical record of the metadata associated with the virtual meeting may be generated and stored in the record database 350. In an example, the metadata for the virtual meeting may include a listing of the participants who were invited to the virtual meeting, a listing of the participants who attended the virtual meeting, phone numbers or email addresses associated with the participants who attended the virtual meeting, a date and time of the virtual meeting, a topic of the virtual meeting, when the virtual meeting was scheduled, when a participant accepted the invitation, a location of the virtual meeting (including the physical location of remote participants), whether a participant enabled audio/video/content sharing during the virtual meeting, an order of when participants joined or left the meeting, a duration of the virtual meeting, a device from which a participant joined the virtual meeting, and the like. In some embodiments, the metadata may include a name of a presenter during a virtual meeting and how long the presenter presented during the virtual meeting. In still further embodiments, the metadata may include information related to content shared during the virtual meeting. For example, the metadata may include a name of a file that was shared or presented during the virtual meeting or chat messages that were exchanged during the virtual meeting. In still further embodiments, the metadata may include information regarding other virtual meetings. For example, the metadata may include other virtual meetings scheduled around the same time as the virtual meeting or information regarding similar virtual meetings, such as whether the current virtual meeting is a continuation of a previous virtual meeting or a rescheduling of another virtual meeting.

The metadata may be gathered from both the virtual meeting invitation associated with the virtual meeting and from the virtual meeting itself. In some embodiments, when a virtual meeting is recorded, the historical record for that virtual meeting may include the recording as well as the metadata information associated with the virtual meeting.

In some embodiments, metadata associated with the virtual meeting may be gathered from an external source. That is, an external system may provide additional information that may be included in the metadata for the virtual meeting. For example, an external system may provide additional information about a participant, such as the participant's role in the organization, or may provide additional information relevant to the timing of the virtual meeting, such as the weather at the time that the virtual meeting was held. By providing additional information related to the virtual meeting this can enable searchers to search for historical records using additional information, such as searching for a virtual meeting that occurred on “a hot day” because the searcher recalls small talk about how hot it was out that day. Additionally, by utilizing additional information from sources external to the video conference provider, this can allow access to confidential information that may be processed locally on a participant's device thereby providing more data for a historical record while protecting the participant's confidential information.

Once the recording is terminated or the meeting is ended, a historical record may be generated for the recording or the metadata information and stored in a record database 350. In some embodiments, the recording or the metadata information may be processed to generate a historical record. For example, the recording may be processed by a contextual comparison engine 360. The contextual comparison engine 360 may be hosted by the video conference provider 310 or may be hosted by a third party. In some embodiments, the contextual comparison engine 360 may be locally or remotely executed.

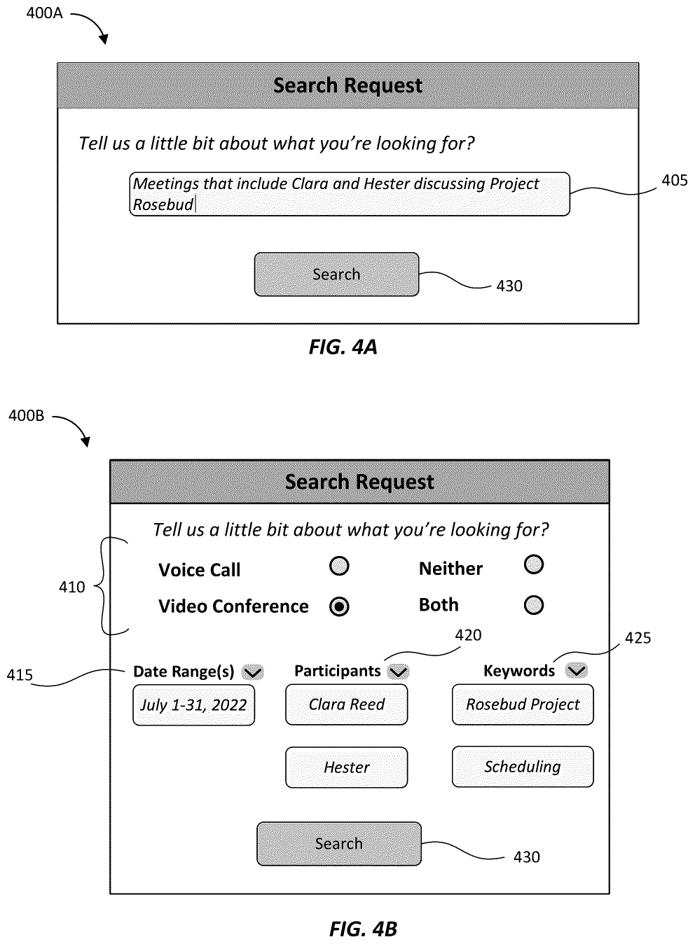

The contextual comparison engine 360 may process the recording or metadata to generate one or more historical records. For example, as will be discussed in greater detail below with reference to FIGS. 4-8, the recording or metadata may be processed to identify the characteristics of the historical record(s). Characteristics of the historical record(s) may include participants of the historical record, a date and time of the historical record, prominent words (e.g., words that are used at an increased rate over other words within the recording) of the historical record, and prominent participants (e.g., participants who speak or are visible on the recording at an increased rate over other participants) of the historical record. In other words, the contextual comparison engine 360 may process the recording or the metadata to generate one or more historical records that includes characteristics (e.g., context) for the historical record regarding the content of the virtual meeting.

In some embodiments, the contextual comparison engine 360 may generate a correlation between a historical record with other historical records that are stored within the record database 350. Specifically, the contextual comparison engine 360 may generate a correlation between the characteristics of a historical record with the characteristics of other historical records. For example, a correlation between the historical record of the recording may be generated based on a topic of the virtual meeting, participants of the virtual meeting, a host of the virtual meeting, or a prominence factor, each of these being a characteristic of the historical record. The prominence factor may correspond to the prominence of specific words or the prominence of a participant in a virtual meeting. For example, if the term “Project X” is used within a first historical record at an increased rate over other words (such as the term being used 27 times), then the contextual comparison engine 360 may identify a second and third historical record in the record database 350 that also have a high word prominence for the term “Project X.” The context comparison engine 360 may then create a correlation between the first historical record and the second and third historical records. As will be described in greater detail below, when the first historical record is provided in a search result, the second and third historical records may also be provided in the search result or in a related result due to this correlation.

The contextual comparison engine 360 may store past search requests and results. Following the above example, if a fourth historical record is selected in past search results by a searcher for a search request including the term “Project X,” then a correlation may be created between the first historical record and the fourth historical record. In some embodiments, correlations generated between various historical records may be stored by the record database 350 and used to identify relevant historical records during search inquiries. In other embodiments, correlations may be generated in response to a search request. Any correlation that is generated in response to a search request may be saved to the record database 350 to be used for future search inquires.

In some embodiments, the contextual comparison engine 360 may employ one or more machine learning (ML) techniques. In an example embodiment, the contextual comparison engine 360 may use ML to identify correlations for searchers. For example, the contextual comparison engine 360 may use ML to identify correlations for searchers that are part of the same organization or department, based on past searches, category of search subject matter, and the like. Following the example of identifying correlations for searchers that are part of the same organization, the contextual comparison engine 360 may identify one or more correlations between historical records based on the searcher being part of a specific organization's department. For example, the contextual comparison engine 360 may generate a tag for historical records that involve finance such to identify a correlation if the searcher is from the finance department. In another example embodiment, the contextual comparison engine 360 may use ML techniques to identify correlations based on past searchers. For example, the contextual comparison engine 360 may identify that searchers using one search term, such as “Project Start,” are actually searching for historical records involving another term “Getting Started Collaboration.” Based on this, the contextual comparison engine 360 may tag the term “Getting Started Collaboration” to be relevant to a search term involving “Project Start,” regardless of whether the participant identifies the term as part of his or her search request.

Referring now to FIG. 4A, a search request prompt 400A is provided, according to an embodiment herein. FIG. 4B provides another example search request prompt 400B, according to another embodiment herein. FIGS. 4A and 4B illustrate examples of how the format of a search request may vary. For example, as illustrated, the prompt 400A provides for a free-form search request to be submitted, such as using natural language. As shown, prompt 400A may provide a dialog box 405 into which a searcher may insert his or her inquiry. Because the search request is provided via the dialog box 405, this can allow the search request to be submitted in everyday vernacular. That is, the searcher can simply insert a statement of what he or she is looking for, such as the illustrated statement of FIG. 4A or a question, such as “in what meeting did Clara and Hester discuss Project Rosebud?”

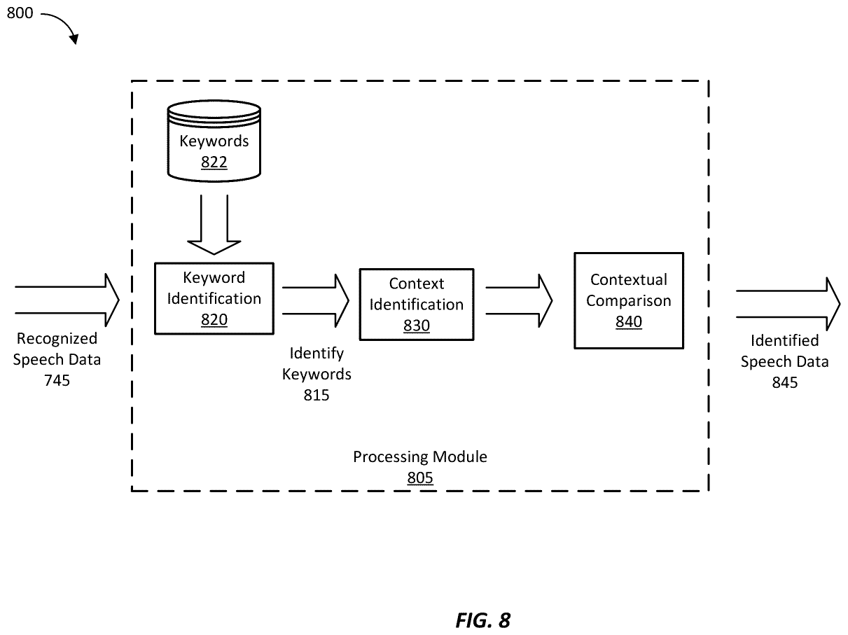

The search request statements inserted into the dialog box 405 may be processed, such as by using semantic analysis, to identify one or more search elements from the properties provided in the search request statement. The properties of the statement may be parsed by a contextual comparison system, such as the contextual comparison system 800 discussed in greater detail below with respect to FIG. 8, or by a contextual comparison engine, such as the contextual comparison engine 360 discussed above with respect to FIG. 3. In other embodiments, the video conference provider 310 may process the properties of the statement to determine one or more search elements from the statement.

The one or more search elements may include keywords from which a search inquiry may be performed. For example, for the illustrated statement of “Meetings that include Clara and Hester discussing Project Rosebud,” the properties of “Clara,” “Hester,” and “Project Rosebud” may be identified. From the properties of the search request statement, search elements may be gathered to provide a more robust search inquiry. For example, because the properties of the statement do not include Clara's last name, the contextual comparison engine may determine Clara's last name prior to performing the search inquiry. In an example embodiment, the contextual comparison engine 360 may determine a profile associated with the searcher and determine therefrom a contact record containing the first name “Clara” associated with the searcher. From the contact record, the contextual comparison engine 360 may identify “Reed” as Clara's last name and update the search element “Clara” to be “Clara Reed.” The properties of the search request statement may also be used as search elements themselves. For example, “Clara” may be used as a search element.

In some embodiments, one or more of the search elements may be assigned a search weight or priority. The search weight may influence how important that search element is to the searcher within a given search request. For example, the searcher may know that Hester was part of the virtual meeting but is not certain that Clara attended. As such, the searcher may assign the search element of “Hester” a greater weight than “Clara.” A greater search weight may increase the requirement for that search element to be present in the historical record. For example, the contextual comparison engine 360 may provide historical records that include “Hester” but not “Clara” above other historical records that include both search elements if other search elements are present in those historical records. In some embodiments, the contextual comparison engine 360 may modify the search weights assigned to different search elements to provide various search results. For example, the contextual comparison engine 360 may assign “Hester” and “Clara” equal search questions for a first search inquiry and then assign “Hester” a greater search weight than “Clara” based on the searcher's input for a second search inquiry. The contextual comparison engine 360 may then compare the first search results and the second search results to identify relevant historical records. In other embodiments, the contextual comparison engine 360 may provide the first search results and the second search results to the searcher for review.

Additional search elements unrelated to the properties of the search request statement may also be identified prior to performing the search inquiry. Following the example from above, the contextual comparison engine 360 may determine that the job title of the searcher is “Scheduling Director.” Based on the searcher's job title, a search element of “schedule” may be added to the search inquiry. Similarly, based on the searcher's (or Clara's or Hester's) department or organization, a name of the department or organization may be added to the search inquiry.

Another example of a search element that may be added to the search inquiry may be identified from past contextual correlations. As described, when a historical record is generated, correlations between past search requests and search results are identified and saved for further search inquiries. These past search correlations may be used to provide additional context for a search request. Following the above example, based on a past search correlation, the contextual comparison engine 360 may identify that whenever a searcher requests a historical record involving “Clara Reed,” the relevant historical record selected by the searcher from the search results includes “Olivia Johnson” in 89 percent of the cases. As such, “Olivia Johnson” may be added as an additional search element to the search request provided via the prompt 400A. In some examples, the searcher may be prompted about whether to add one or more additional search elements to the search inquiry, potentially including explanations for why the additional search elements are suggested, from which the searcher may select none, some, or all to include.

As noted above, search requests may be submitted in a variety of formats. The search request prompt 400B in FIG. 4B illustrates another format in which a search request may be submitted. Instead of allowing for a free-form search request, the search request prompt 400B includes specified options for the searcher to submit his or her request. For example, as illustrated, the search request prompt 400B may include selectors 410 from which the searcher can specify the format of the historical record that he or she is looking for. As shown, the searcher could select that he or she is looking for historical records corresponding to a voice call, a video conference, neither, or both.

The search request prompt 400B may also include options 415, 420, and 425 into which the searcher can provide the details of the search request. For example, for option 415, the searcher can input a date range for when the virtual meeting occurred, for option 420, the searcher can input the names of participants that were involved in the virtual meeting, and for option 425, the searcher can input keywords that are relevant to the virtual meeting. From the inputs received via options 415-425 and selectors 410, the contextual comparison engine 360 may identify the search elements, including additional search elements as discussed above.

Once the searcher has input his or her search request, the searcher may select a search option 430. Upon selection of the search option 430, a search inquiry may be performed. In some embodiments, the search inquiry may be performed by the contextual comparison engine 360, by the video conference provider 310, or by a combination thereof. In other embodiments, the search inquiry may be performed by a third party. In such cases, the third party may query the contextual comparison engine 360, the video conference provider 310, the record database 350, or any combination thereof to perform the search inquiry.

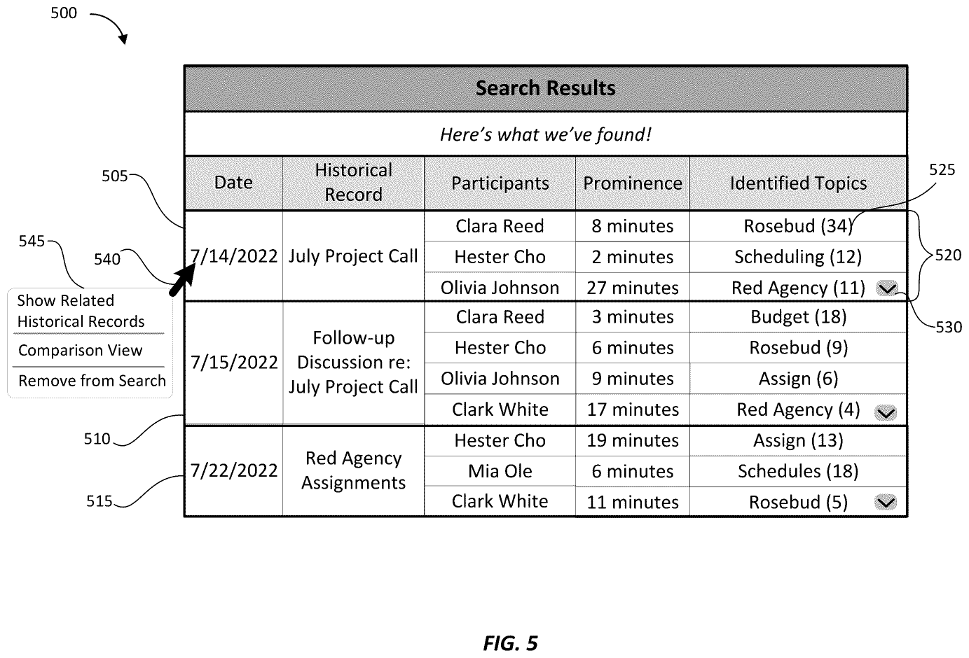

Once a search inquiry is performed, the searcher may be provided with the search results of the inquiry. Turning now to FIG. 5, an example of search results 500 is provided, according to an embodiment herein. The search result 500 includes three historical elements that were identified during a search inquiry. As shown, the search result 500 includes a first historical record 505, a second historical record 510, and a third historical record 515. The search results 500 may provide the searcher with historical records that were identified based on the search request submitted by the searcher. For example, the historical records 505, 510, and 515 provided on the search results 500 may have been identified based on the search request submitted via the prompt 400A or the prompt 400B. It should be understood that while the search results 500 only provide three historical records, any number of historical records may be provided in the search results 500.

The search results 500 may provide relevant characteristics for each of the historical records 505, 510, and 515. For example, as illustrated, the search results 500 may provide the date on which the virtual meeting occurred, the title of the historical record which may be based on the title of the corresponding virtual meeting, a listing of participants of the virtual meeting, a prominence for each of the participants in the listing of participants, and identified topics within the historical record. Each of these may be considered to be the identified characteristics of the historical record based on the search request. Because the provided characteristics are based on the search request, only relevant characteristics of the historical record may be provided on the search results 500. For example, for the first historical record 505, there may have been more participants who joined the virtual meeting than those provided on the participant listing. However, since the other participants didn't speak or only had minor prominence during the virtual meeting, the names of the other participants may not be included on the participant listing for the first historical record 505.

Each of the historical records 505, 510, and 515 may have been identified by the contextual comparison engine 360 because the characteristics of the historical record were relevant to the search elements of the search request. For example, the search request included the properties “Clara” and Hester” which were used to determine the search elements “Clara Reed” and “Hester Cho.” As shown, each of the identified historical records 505, 510, and 515 include one or both of Clara Reed and Hester Cho as participants and may have been identified at least in part because Clara Reed and Hester Cho were participants in the corresponding virtual meeting.

In some embodiments, to identify historical records based on a search request, historical records within the record database 350 may be given a relevancy score. In an example embodiment, any historical record that did not include a predetermined number of search elements, may have been given a low relevancy score and, in turn, removed from the search pool. For example, if a historical record did not include at least two of the search elements “Clara Reed,” “Hester Cho,” “Rosebud,” or “Schedule,” then that historical record may have been given a low relevancy score and removed from the set of historical records of the search pool.

In contrast, if a historical record contains a higher number of search elements, then the historical record may be given a higher relevancy score. For example, the first historical record 505 may have a higher relevancy score than the third historical record 515 because the characteristics of the first historical record 505 includes the search elements “Clara Reed,” “Hester Cho,” “Rosebud,” and “Scheduling,” while the third historical record 515 does not include “Clara Reed.”

Beyond merely containing the search element in the characteristics of the historical record, the prominence of a search element may also be analyzed to determine a relevancy score for the historical record. The prominence of a historical record characteristic may correspond to how prevalent or prominent that characteristic is in the historical record. For example, a participant prominence may correspond to how many minutes a participant speaks or is the primary focus of the historical record. As illustrated, for the first historical record 505, Clara Reed may have a prominence factor of 8 minutes. This may mean that Clara Reed speaks or is the primary focus of the first historical record 505 for 8 minutes. In contrast, Hester Cho may have a prominence factor of 2 minutes and Olivia Johnson may have a prominence factor of 27 minutes. The prominence factors for various characteristics of a historical record can provide the search with additional context when reviewing the search results, allowing the searcher to better understand the material of the historical record without having to review the entire historical record.

Another type of prominence factor that may be identified for historical record characteristics is a topic or word prominence. The topic or word prominence factor may indicate the prevalence or prominence of a word or phrase in the historical record. For example, for the first historical record 505, the identified topics 520 include the terms “Rosebud,” “Scheduling,” and “Red Agency.” Next to each of the terms in the identified topics 520, a count 525 may be provided. The count 525 may indicate the number of times the term is used in the historical record. For example, the number of times the term “Rosebud” is spoken, shown, shared, or otherwise present in the first historical record 505 is 34, while the terms “Scheduling” and “Red Agency” have a count of 12 and 11, respectively. Again, the prominence factor of identified topics in a historical record may provide the searcher with context when trying to identify a relevant historical record. For example, if the searcher is looking for a historical record in which the Rosebud Project is the main topic, the searcher may determine that the first historical record 505 is more relevant than the third historical record 515 because the term “Rosebud” is only used five times in the third historical record 515 and therefore determine that the discussion of the Rosebud Project in the third historical record 515 must be ancillary to the primary discussion.

In some embodiments, a predetermined number of characteristics for a given historical record may be provided in the search results. If the searcher wants to analyze additional characteristics of a historical record, the searcher may be able to select the historical record to request additional information. For example, as illustrated, for the first historical record 505, the searcher may desire to view the prominence of additional identified topics. To do so, the searcher may select the expand option 530. Upon selection of the expand option 530, additional identified topics along with their prominence factors may be provided to the searcher. Although not shown, the searcher may request to view additional information for each of the characteristics of a given historical record.

In some embodiments, the searcher may wish to gather more information for a given historical record. For example, the searcher may select the first historical record 505 with a cursor 540 and be provided with a menu 545. The menu 545 may provide an option to show related historical records, an option to show a comparison view, and an option to remove the historical record from the search. If the search selects to remove the historical record from the search, then the first historical record 505 may be identified as irrelevant and removed from the search results 500. The contextual comparison engine 360 may also be updated the search based on the searcher's removal of the first historical record 505. For example, the contextual comparison engine 360 may generate, change correlation weights, or remove correlations based on the search elements and the characteristics of the first historical record 505.

If the searcher selects the option to show related historical records, the contextual comparison engine 360 may update the search results 500 to show historical records that are related to the first historical record 505. For example, historical records that were generated on the same day may be considered related, or historical records containing the same participants may be considered related. In some embodiments, the searcher may be able to define what related characteristics he or she wishes to identify in additional historical records.

It should be understood that a given search element or given characteristic may not be limited to a single term but rather may include variations of a root term. For example, for the term “Scheduling,” the search element or the characteristic of a historical record may also include variations such as “Schedule,” “Schedules,” and “Scheduled,” all based on the root “schedule.” However, for ease of discussion, a single variation of the term, such as “Scheduling” is used.

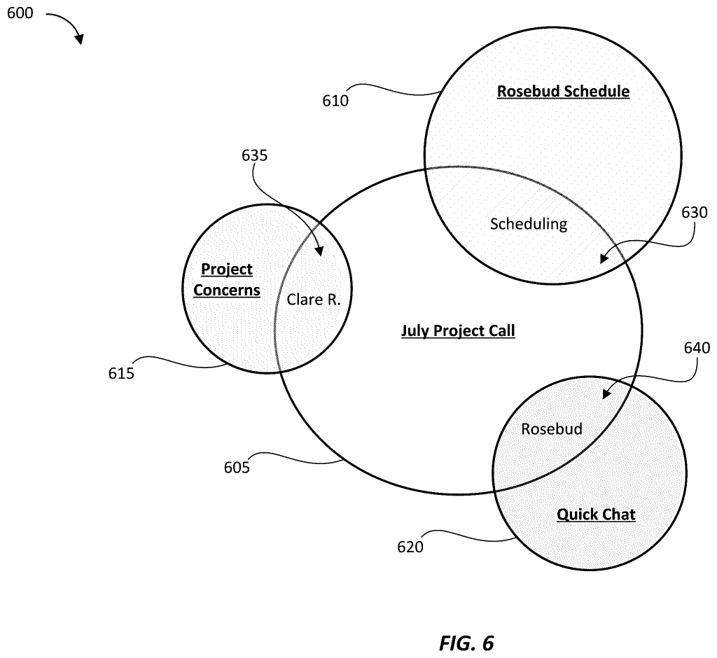

In some embodiments, the searcher may select the option to show a comparison view. Turning now to FIG. 6, an example contextual comparison view 600 of a set of historical records is provided, according to an embodiment herein. The contextual comparison view 600 provides a contextual comparison of a set of historical records. For example, the comparison view 600 provides a contextual comparison of four historical records: a first historical record 605, a second historical record 610, a third historical record 615, and a fourth historical record 620. The first historical record 605 may be the same or similar to the first historical record 505. For example, the first historical record 605 may be the historical record from which the searcher requested the comparison view 600. As such, the first historical record 605 is provided as the central or main historical record from which comparisons are made. It should be understood, however, that there may be more than one main historical record and any number of historical records may be provided in the comparison view 600. Additionally, although only one characteristic is used to illustrate the comparisons between the historical records 605-620, any number of characteristics may be used. The contextual comparison view 600 is illustrated and discussed with a limited number of historical records and characteristics for ease of discussion.

As shown, a similar characteristic may be identified for comparison between each of the historical records 605-620. For example, the prominence of the characteristic “Scheduling” 630 may be identified as similar between the first historical record 605 and the second historical record 610. Similarly, the prominence of the characteristic “Clare Reed” 635 may be identified as similar between the first historical record 605 and the third historical record 615, and the prominence of the characteristic “Rosebud” 640 may be identified as similar between the first historical record 605 and the fourth historical record 620.

The overlap for each of the characteristics between the first historical record 605 and the second, third, and fourth historical records 610-620 may indicate that the identified characteristic has a high prominence factor for both of the historical records. For example, the characteristic “Scheduling” 630 may indicate that the characteristic “Scheduling” has a high prominence factor for both the first historical record 605 and the second historical record 610. The contextual comparison view 600 can allow a searcher to continue searching for relevant historical records by seeing related historical records as well as the relationship between related historical records.

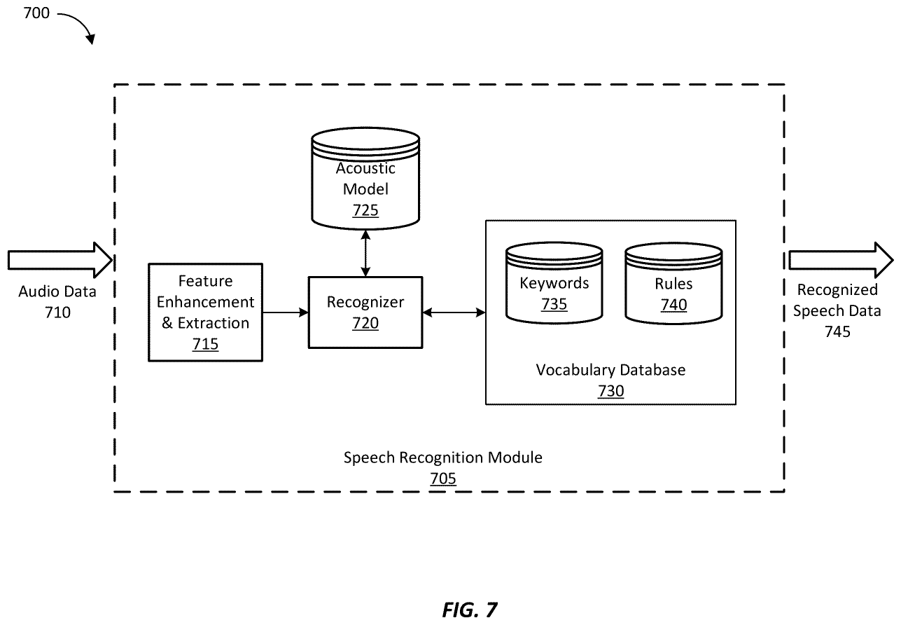

Turning now to FIG. 7, an example speech recognition system 700 that may be used for providing the contextual comparison engine for search and review of historical records is provided. The speech recognition system 700 may be executed locally or remotely. For example, the speech recognition system 700 may be locally executed on a client device, such as the client device 340a; however, in other embodiments, the speech recognition system 700 may be cloud-based and/or remotely executed by a video conference provider, such as the video conference provider 310, or a third-party system.

The speech recognition system 700, along with the contextual comparison system 800 described in greater detail with respect to FIG. 8, may be used to perform one or more of the contextual comparison search and review functions described herein. For example, in some embodiments, the speech recognition system 700 may be used to identify keywords and characteristics within a historical record. The speech recognition system 700 may process an audio track associated with a historical record to identify keywords and characteristics within the historical record. In other embodiments, the speech recognition system 700 may be used to process the audio tracks of a virtual meeting or a recording of the virtual meeting to generate a transcript for a historical record.

To perform speech recognition, the speech recognition system 700 may include a speech recognition module 705. The speech recognition module 705 may receive audio data 710. The audio data 710 may correspond to audio captured by the client device 340a, for example by a microphone. In other embodiments, the audio data 710 may be received from the video conference provider 310. The audio data 710 may be a recording of an audio track or may be a transcript of the audio track. The speech recognition module 705 may be or include a speech recognition system or model as known in the art. The following is an example speech recognition module following an example speech recognition process, however, it should be understood that other speech recognition modules or processes may be used.

Once the audio data 710 is received by the speech recognition module 705, the audio data 710 may be processed by a feature enhancement and extraction module 715. The feature enhancement and extraction module 715 may analyze the audio data for features corresponding to words and then enhance and extract any identified features. The identified features may correspond to audio waveforms present in human speech.

The speech recognition module 705 may also include a recognizer 720. The recognizer 720 may receive the identified features from the audio data 710. The recognizer 720 may employ an acoustic model 725 and a vocabulary database 730 to determine or associate the identified features in the audio data 710 to one or more words.

In an example embodiment, the acoustic model 725 may analyze the raw audio waveforms in the identified features and determine a corresponding phoneme for each waveform. In some embodiments, this is performed at the character or subword level. The vocabulary database 730 may be a language model. The vocabulary database 730 may include a rules database 740 and a word database 735. The rules database 740 may provide various rules for speech, allowing the recognizer to discard any association of identified features (e.g., audio waveforms) to phonemes that are improbable given the constraints of proper grammar and the topic of discussion. Once an appropriate mapping of the identified features to phonemes is generated, the recognizer 720 may determine words associated with the phonemes. The words may be based on the words database 735.

Once the phonemes are associated with respective words, recognized speech data 745 is generated. It should be understood that this process may be performed in real-time, or nearly in real-time. For example, the speech recognition module 705 may generate the recognized speech data 745 during the meeting as the audio streams are being received by the video conference provider 310 or another system that is hosting the speech recognition system 700. The recognized speech 745 may be then used to perform one or more of the contextual comparison search and review functions as described herein.

Turning now to FIG. 8, a contextual comparison system 800 is provided. The contextual comparison system 800 may include processing module 805 that is used to perform one or more of the contextual comparison search and review functions described herein. For example, in one case, the recognized speech 745 may be received from the speech recognition system 700 to generate correlations between the historical record for which the audio track is being processed and other historical records, or the recognized speech 715 may be received from the speech recognition system 700 to generate one or more prominence factors for characteristics of the historical record.

The recognized speech 745 may be received by the keyword identification system 820. The keyword identification system 820 may identify one or more keywords in the recognized speech data 745. The database of known keywords 822 may be queried to identify any keywords in the track of recognized speech data 745. Keywords in the keyword database 822 may be based on the search elements relating to the search request that is being processed. In other embodiments, the keywords 822 may be queried to identify any keywords in the track of recognized speech data 745 that relate to the searcher. The keywords identified in the track may be used to tag the historical record and help generate correlations. For example, if the search request is transmitted by the client device 340a, then the keywords in the keyword database 822 may relate to or be based on a participant A, who corresponds to the client device 340a. The keywords may include words relating to the identity of participant A or personally identifiable information about participant A, such as the first and last name of participant A. In some cases, the keywords may include an office or location of participant A. Other keywords may include the names of projects, areas, or topics that participant A is involved in, as well as contacts associated with the participant A.

In still further other embodiments, the keywords 822 may be queried to identify any keywords in the track of recognized speech data 745 to identify the participant who is speaking in the audio track. By identifying the participant who is speaking, the prominence factor for the participant can be readily determined. In such cases, the keywords may include one or more emotion expressions, such as a distinct laughter, or identifiable speech characteristics, such as an accent, of a participant.

The keywords in the keyword database 822 may be gathered from participant A or from the client device 340a. For example, upon enabling the contextual comparison engine 360, participant A may be prompted to allow access of a processing module 805 to the participant A's contact list, email, or other documents present on the client device 340a. In other embodiments, the processing module 805 may receive some or all the keywords from the participant's profile with the video conference provider 310. In still other embodiments, the processing module 805 may gather keywords from applications on the client device 340a. If the processing module 805 has permission to search other applications on the client device 340a, the processing module 805 may gather keywords from folders, calendars, emails, or other applications running on the client device 340a.

It should be understood that a keyword may include more than one word. For example, “Project Alpha” may be a “keyword” as indicating that the phrase “Project Alpha” is a personally identifiable characteristic for participant A. Depending on various implementations, multi-word keywords may be treated as a single keyword or as multiple associated keywords. Further, a keyword may have multiple different forms. For example, a keyword may be a verb, which may be spelled different depending on context, e.g., it is conjugated differently depending on tense, subject, etc. Thus, a keyword may include variants of a base word, e.g., “look for,” “looking for,” and “looked for.” In some examples each of these may be a distinct keyword, while in other examples, the variants may be associated with a base term, e.g., “look,” that is used as the keyword. However, any suitable approach to recognizing keywords may be used.

If one or more keywords 815 is recognized, the processing module 805 then may identify a context 830 associated with the keyword 815. In this example, to identify a context, the processing module 805 may employ a trained machine learning (“ML”) technique to semantically analyze the speech or transcript associated with the identified keyword 815 to determine additional related keywords and/or descriptors. To perform the analysis, the trained ML technique may be provided the keyword(s) and a predetermined number of words near the keyword, e.g., preceding and following the keyword(s), such as five to ten words preceding and following the keyword(s). Words such as articles (e.g., “a”, “the”) or prepositions such as “of” or “for” may be omitted from the word count in some examples.

Since people may use jargon or colloquial terms to refer to particular actions; the context identification 830 functionality may normalize recognized words to specific meanings. For example, the terms “kids,” “offspring,” “kiddos,” “little ones,” etc. all refer to children. Thus, the context identification 830 functionality may map such terms to have a single meaning (e.g., children). Such mappings may be provided for multiple different phrases and corresponding terms. Similarly, synonyms or words related to keywords may also be identified.

Once the context identification 830 has identified the one or more keywords 815 and identified the context of the identified keywords 815, the processing module 805 may perform a contextual comparison 840. The processing module 805 may determine, based on the identification of the keywords 815, and the context of the keywords, that the keywords 815 include search elements, terms relating to the search results properties, or the characteristics of the historical record. Using the keywords, the contextual comparison engine 840 may process the keywords 815 in the audio data to generate context 845 for the historical record. The context 845 may include the characteristics of the historical record, a transcription of the historical record, or correlations between the historical record and other historical records in the record database 350.

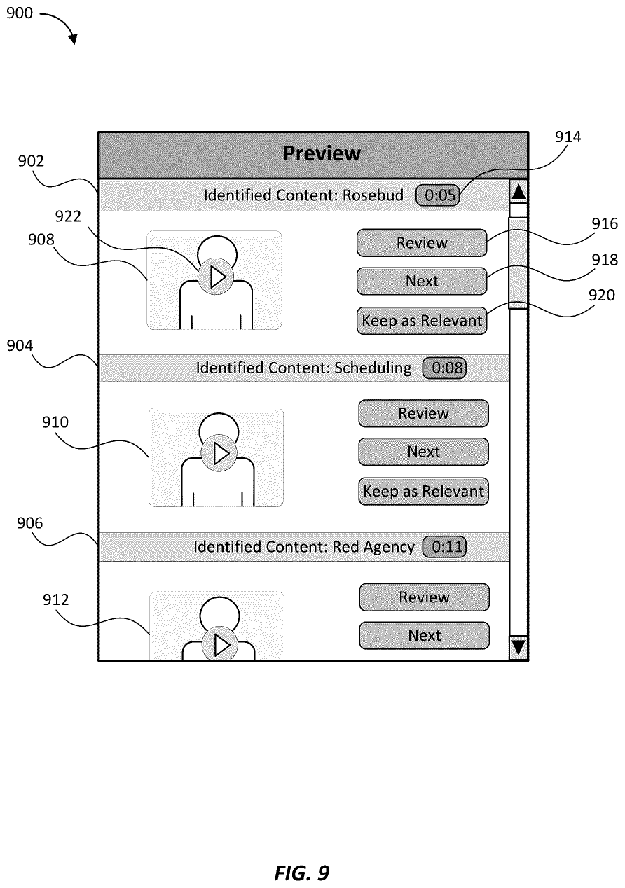

Referring now to FIG. 9, a prompt 900 for previewing a section of a historical record is provided, according to an embodiment herein. The prompt 900 may provide a searcher with a quick preview of the content of a historical record. Specifically, the prompt 900 may provide the searcher a quick preview of a section of a historical record relating to one or more characteristics of the historical record.

Following the example from FIG. 5, the prompt 900 may provide a preview of the sections of the historical record in which the prominent identified characteristics are present in the first historical record 505. As shown, the prompt 900 may include a pane 902 previewing sections of the historical record in which the term “Rosebud” is used, a pane 904 previewing sections of the historical record in which the term “Scheduling” is used, and a pane 906 previewing sections of the historical record in which the term “Red Agency” is used. In each of the panes 902-906, a clip of the identified characteristic from the historical record may be provided. For example, the pane 902 may provide clip 908, the pane 904 may provide clip 910, and the pane 906 may provide clip 912. Each of the clips may provide a preview of a section of the historical record containing the identified characteristic. If the user selects the play button 922, the clip may play the preview of the section. The preview may include a predetermined amount of audio or video stream before and after the identified characteristic is used to provide the searcher with context. For example, if the identified characteristic is the term “Rosebud,” the preview may include the 30-seconds leading up to the use of the term “Rosebud” and the 30-seconds following the use.

Each of the panes 902-906 may include a time 914 at which the identified characteristic occurs within the historical record. This may allow the participant to orient the preview within the overall historical record. Each of the panes 902-906 may also include a plurality of options for the identified characteristic. For example, the prompt 900 may include a review selection 916, a next selection 918, and a keep as relevant selection 920. The review selection 916 may allow the participant to review the identified characteristic. For example, upon selection of the review selection 916, the clip 908 may play the section of the historical record in which the identified characteristic is used. The review selection 916 may be used in place of the play button 922.

Since the identified characteristic is generally used or is present in the historical record more than once, the next selection 918 may allow the searcher to go to the next use of the characteristic in the historical record. Upon selecting the next selection 918, the clip 908 may update to the next section of the historical record in which the characteristic is present.

If the searcher would like to mark a particular use of the characteristic in the historical record as relevant, the searcher can select the keep as relevant selection 920. Upon selection of the keep as relevant selection 920, the contextual comparison engine 360 may analyze the other characteristics present in the preview section to update correlations and the search inquiry. For example, the searcher may mark a use of the term “Rosebud” as relevant (via the keep as relevant selection 920) because Clare Reed is discussing details of the Rosebud Project that are relevant to the searcher. Based on the identification of the section of the historical record as relevant, the contextual comparison engine 360 may generate a correlation between the term “Rosebud” and Clare Reed such that future searchers for the term “Rosebud” may also include the search term Clare Reed. Similarly, the contextual comparison engine 360 may analyze the section to identify additional characteristics relating to the terms used for the details of the Rosebud Project that are relevant to the searcher. These characteristics may be used to generate correlations between the searcher and the term “Rosebud” or to generate correlations for future searches involving the term “Rosebud.”

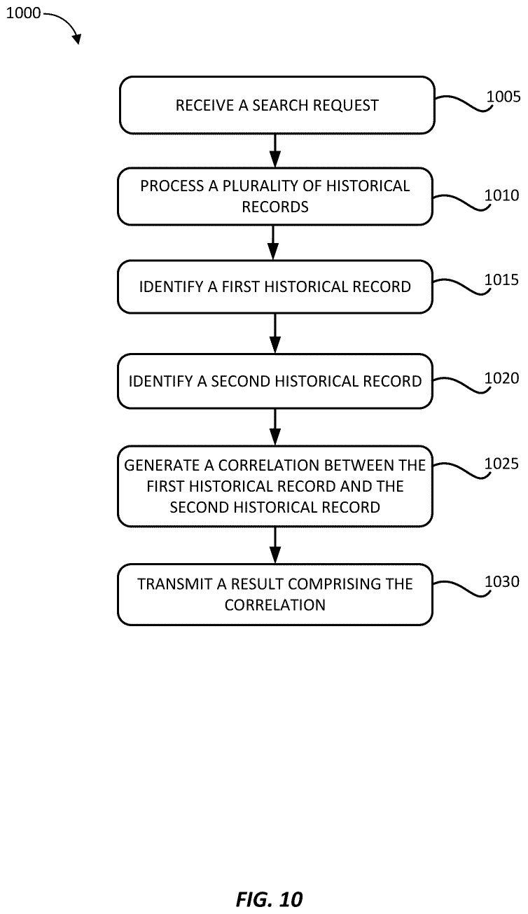

Referring now to FIG. 10, a flowchart of an example method 1000 for providing a contextual comparison engine for historical record search and review is provided. The description of the method 1000 in FIG. 10 will be made with reference to FIGS. 3-9, however any suitable system according to this disclosure may be used, such as the example systems 100, 200, and 300, shown in FIGS. 1, 2, and 3.

The method 1000 may include step 1005. At step 1005, a search request may be received. The search request may be received from a first device. The search request may include one or more properties to identify a set of historical records from a database of historical records. For example, the search request may be similar to the search request prompt 400A or the search request prompt 400B. In some embodiments, step 1005 may include determining, based on a profile associated with the first client device, a first search element and performing a search of the database of historical records based on the first element. In other embodiments, step 1005 may include identifying a previous search request comprising similar properties to the one or more properties, determining, based on the previous search request, a first search element, and performing a search of the database of historical records based on the first search element.

The method 1000 may also include step 1010. At step 1010, the method 1000 may include processing one or more historical records based on the one or more properties of the search request. For example, the video conference provider 310 or the contextual comparison engine 360 may process the one or more historical records based on the search request received from the first client device. In some embodiments, step 1010 may include determining a relevance score of each of the plurality of historical records based on the one or more properties and removing from the result, one or more historical records comprising a low relevance score. Determining the relevance score for each of the plurality of historical records may include one or more of determining a prominence of the historical record for related search requests, determining a presence of one or more participants within the historical record, determining a prominence of one or more keywords within the historical record, or determining a similarity between the historical record and a relevant historical record.

In other embodiments, step 1010 may include performing speech recognition on an audio track associated with one or more of the plurality of historical records, generating a transcript of the audio track associated with the one or more of the plurality of historical records, storing the transcript of the audio track associated with the one or more of the plurality of historical records, and identifying, based on the transcript, the first historical record and the second historical record.

The method 1000 may also include step 1015. At step 1015, a first historical record may be identified. The first historical record may include a recording of a virtual meeting or include metadata associated with a virtual meeting. If the first historical record is a recording of a virtual meeting, then the method 1000 may include generating the recording of one or more audio or video tracks corresponding to the one or more audio or video streams exchanged during the virtual meeting. If the first historical record includes metadata, then the method 1000 may include generating a record of the metadata corresponding to the virtual meeting and adding the record of the metadata to the first historical record. In some embodiments, the metadata corresponding to the virtual meeting may include one or more of a date and time of the virtual meeting, a listing of the plurality of participants from the virtual meeting, a duration of the virtual meeting, or a topic associated with a request for the virtual meeting.

The first historical record may include a first plurality of characteristics based on processing the one or more historical records. The first plurality of characteristics may be correlated with the one or more properties from the search request.

The method 1000 may also include a step 1020. At step 1020, a second historical record may be identified. The second historical record may include a recording of a virtual meeting or include metadata associated with a virtual meeting. The second historical record may include a plurality of characteristics based on processing the one or more historical records. The second characteristics may be correlated with the one or more properties from the search request or be correlated with at least one characteristic of the first plurality of characteristics.

The method 1000 may also include step 1025. At step 1025, the method 1000 may include generating a correlation between the first plurality of characteristics of the first historical record and the second plurality of characteristics of the second historical record. For example, the contextual comparison engine 360 may generate the correlation.

The method 1000 may also include step 1030. At step 1030, the method 1000 may include transmitting a result including the correlation between the first historical record and the second historical record. The result may be transmitted to the first client device. Optionally, the method 1000 may include providing, to the first client device, a preview of a section of the first historical record, wherein the section includes a subset of the first plurality of characteristics of the first historical record. For example, if the first historical record is a recording of a virtual meeting, the method 1000 may include providing, to the first client device, a clip of one or more audio or video streams from the virtual meeting, wherein the one or more audio or video streams correspond to the subset of the first plurality of characteristics.

In some embodiments, the method 1000 may include receiving, from the first client device, a selection to further analyze the plurality of historical records based on a first characteristic of the first plurality of characteristics of the first historical record, generating, based on the first characteristic, a second correlation between the first historical record and a third historical record, wherein the third historical record comprises a third plurality of characteristics, and transmitting, to the first client device, the second correlation between the first historical record and the third historical record.

In still further embodiments, the method 1000 may include receiving, from the first client device, a selection of the first historical record within the result and providing, to the first client device, an analysis of the one or more properties for the first historical record. For example, the analysis of the one or more properties for the first historical record may include a prominence of the one or more properties within the first historical record.

In some embodiments, the method 1000 may include establishing, by a video conference provider, a virtual meeting having a plurality of participants, each participant of the plurality of participants exchanging one or more audio or video streams via the virtual meeting, generating the first historical record based on the virtual meeting, and saving the first historical record to a database of historical records.

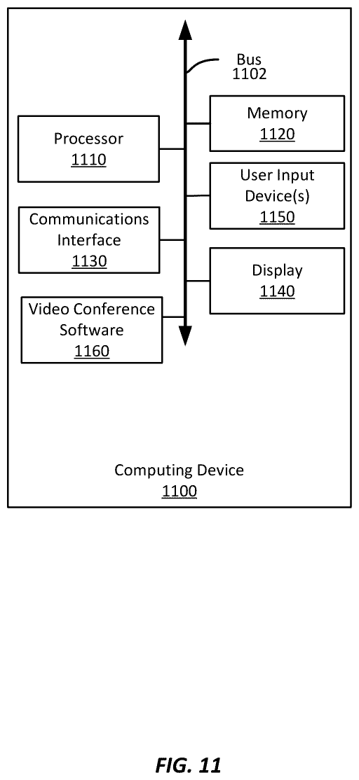

Referring now to FIG. 11, FIG. 11 shows an example computing device 1100 suitable for use in example systems or methods providing a contextual comparison engine for historical record search and review. The example computing device 1100 includes a processor 1110 which is in communication with the memory 1120 and other components of the computing device 1100 using one or more communications buses 1102. The processor 1110 is configured to execute processor-executable instructions stored in the memory 1120 to perform one or more methods for providing a contextual comparison engine for historical record search and review, such as part or all of the example method 1000, described above with respect to FIG. 10. The computing device, in this example, also includes one or more user input devices 1150, such as a keyboard, mouse, touchscreen, video input device (e.g., one or more cameras), microphone, etc., to accept user input. The computing device 1100 also includes a display 1140 to provide visual output to a user.

The computing device 1100 also includes a communications interface 1130. In some examples, the communications interface 1030 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification

As used below, any reference to a series of examples is to be understood as a reference to each of those examples disjunctively (e.g., “Examples 1-4” is to be understood as “Examples 1, 2, 3, or 4”).

Example 1 is a method comprising: receiving, from a first client device, a search request comprising one or more properties to identify a set of historical records from a database of historical records; processing a plurality of historical records based on the one or more properties of the search request; identifying a first historical record based on processing the plurality of historical records, wherein the first historical record has a first plurality of characteristics correlated with the one or more properties; identifying a second historical record based on processing the plurality of historical records, wherein the second historical record has a second plurality of characteristics correlated with at least one of the one or more properties or at least one characteristic of the first plurality of characteristics; generating a correlation between the first plurality of characteristics of the first historical record and the second plurality of characteristics of the second historical record; and transmitting, to the first client device, a result comprising the correlation between the first historical record and the second historical record.

Example 2 is the method of any previous or subsequent Example, wherein receiving, from the first client device, the search request comprises: determining, based on a profile associated with the first client device, a first search element; and performing a search of the database of historical records based on the first search element.

Example 3 is the method of any previous or subsequent Example, wherein receiving, from the first client device, the search request comprises: identifying a previous search request comprising similar properties to the one or more properties; determining, based on the previous search request, a first search element; and performing a search of the database of historical records based on the first search element.

Example 4 is the method of any previous or subsequent Example, wherein processing the plurality of historical records based on the one or more properties of the search request comprises: determining a relevance score of each of the plurality of historical records based on the one or more properties; and removing from the result, one or more historical records comprising a low relevance score.

Example 5 is the method of any previous or subsequent Example, wherein determining the relevance score for each of the plurality of historical records comprises one or more of: determining a prominence of the historical record for related search requests; determining a presence of one or more participants within the historical record; determining a prominence of one or more keywords within the historical record; or determining a similarity between the historical record and a relevant historical record.

Example 6 is the method of any previous or subsequent Example, wherein the method further comprises: receiving, from the first client device, a selection to further analyze the plurality of historical records based on a first characteristic of the first plurality of characteristics of the first historical record; generating, based on the first characteristic, a second correlation between the first historical record and a third historical record, wherein the third historical record comprises a third plurality of characteristics; and transmitting, to the first client device, the second correlation between the first historical record and the third historical record.

Example 7 is the method of any previous or subsequent Example, wherein the first historical record comprises one of: a recording of one or more audio or video tracks corresponding to one or more audio or video streams exchanged during a virtual meeting; or a record of metadata corresponding to the virtual meeting.

Example 8 is the method of any previous or subsequent Example, the method further comprising: establishing, by a video conference provider, a virtual meeting having a plurality of participants, each participant of the plurality of participants exchanging one or more audio or video streams via the virtual meeting; generating the first historical record based on the virtual meeting; and saving the first historical record to a database of historical records.

Example 9 is a system comprising: a non-transitory computer-readable medium; a communications interface; and a processor communicatively coupled to the non-transitory computer-readable medium and the communications interface, the processor configured to execute processor-executable instructions stored in the non-transitory computer-readable medium to: receive, from a first client device, a search request comprising one or more properties to identify a set of historical records from a database of historical records; process a plurality of historical records based on the one or more properties of the search request; identify a first historical record based on processing the plurality of historical records, wherein the first historical record has a first plurality of characteristics correlated with the one or more properties; identify a second historical record based on processing the plurality of historical records, wherein the second historical record has a second plurality of characteristics correlated with at least one of the one or more properties or at least one characteristic of the first plurality of characteristics; generate a correlation between the first plurality of characteristics of the first historical record and the second plurality of characteristics of the second historical record; and transmit, to the first client device, a result comprising the correlation between the first historical record and the second historical record.

Example 10 is the system of any previous or subsequent Example, wherein the first historical record is a recording of a virtual meeting and the processor is configured to execute further processor-executable instructions stored in the non-transitory computer-readable medium to: generate the recording of one or more audio or video tracks corresponding to one or more audio or video streams exchanged during the virtual meeting.

Example 11 is the system of any previous or subsequent Example, wherein the processor is configured to execute further processor-executable instructions stored in the non-transitory computer-readable medium to: generate a record of metadata corresponding to a virtual meeting; and add the record of the metadata to the first historical record.

Example 12 is the system of any previous or subsequent Example, wherein the metadata corresponding to the virtual meeting comprises one or more of: a date and time of the virtual meeting; a listing of the plurality of participants from the virtual meeting; a duration of the virtual meeting; or a topic associated with a request for the virtual meeting.

Example 13 is the system of any previous or subsequent Example, wherein the processor is configured to execute further processor-executable instructions stored in the non-transitory computer-readable medium to: provide, to the first client device, a preview of a section of the first historical record, wherein the section comprises a subset of the first plurality of characteristics of the first historical record.

Example 14 is the system of any previous or subsequent Example, wherein the first historical record comprises a recording of a virtual meeting, and wherein the instructions to provide, to the first client device, the preview of a section of the first historical record further causes the processor to execute further processor-executable instructions stored in the non-transitory computer-readable medium to: provide, to the first client device, a clip of one or more audio or video streams from the virtual meeting, wherein the one or more audio or video streams correspond to the subset of the first plurality of characteristics.

Example 15 is the system of any previous or subsequent Example, wherein the instructions to process the plurality of historical records based on the one or more properties of the search request further causes the processor to execute further processor-executable instructions stored in the non-transitory computer-readable medium to: perform speech recognition on an audio track associated with one or more of the plurality of historical records; generate a transcript of the audio track associated with the one or more of the plurality of historical records; store the transcript of the audio track associated with the one or more of the plurality of historical records; and identify, based on the transcript, the first historical record and the second historical record.

Example 16 is a non-transitory computer-readable medium comprising processor-executable instructions configured to cause one or more processors to: receive, from a first client device, a search request comprising one or more properties to identify a set of historical records from a database of historical records comprising one or more properties; process a plurality of historical records based on the one or more properties of the search request; identify a first historical record based on processing the plurality of historical records, wherein the first historical record has a first plurality of characteristics correlated with the one or more properties; identify a second historical record based on processing the plurality of historical records, wherein the second historical record has a second plurality of characteristics correlated with at least one of the one or more properties or at least one characteristic of the first plurality of characteristics; generate a correlation between the first plurality of characteristics of the first historical record and the second plurality of characteristics of the second historical record; and transmit, to the first client device, a result comprising the correlation between the first historical record and the second historical record.

Example 17 is the non-transitory computer-readable medium of any previous or subsequent Example, wherein the processor is configured to execute further processor-executable instructions stored in the non-transitory computer-readable medium to: identify a second set of properties based on the first plurality of characteristics; identify a third historical record based on the second set of properties, wherein the third historical record comprises a third plurality of characteristics; generate a second correlation between the first plurality of characteristics of the first historical record and the third plurality of characteristics of the third historical record; and transmit, to the first client device, a second result comprising the second correlation of the first historical record and the third historical record.

Example 18 is the non-transitory computer-readable medium of any previous or subsequent Example, wherein the processor is configured to execute further processor-executable instructions stored in the non-transitory computer-readable medium to: receive the first historical record; automatically process the first historical record to determine the first plurality of characteristics; and save the first historical record and the first plurality of characteristics to the database of historical records.

Example 19 is the non-transitory computer-readable medium of any previous or subsequent Example, wherein the processor is configured to execute further processor-executable instructions stored in the non-transitory computer-readable medium to: determine a section of the first historical record corresponding to the first plurality of characteristics; and provide to the first client device, a preview of the section of the first historical record.

Example 20 is the non-transitory computer-readable medium of any previous or subsequent Example, wherein the processor is configured to execute further processor-executable instructions stored in the non-transitory computer-readable medium to: receive, from the first client device, a selection of the first historical record within the result; and provide, to the first client device, an analysis of the one or more properties for the first historical record.

Example 21 is the non-transitory computer-readable medium of any previous or subsequent Example, wherein the analysis of the one or more properties for the first historical record comprises a prominence of the one or more properties within the first historical record.

That which is claimed is:

1. A method comprising:
receiving, from a first client device, a search request comprising one or more properties to identify a set of historical records from a database of historical records;
processing a plurality of historical records based on the one or more properties of the search request;
identifying a first historical record based on processing the plurality of historical records, wherein the first historical record has a first plurality of characteristics correlated with the one or more properties;
identifying a second historical record based on processing the plurality of historical records, wherein the second historical record has a second plurality of characteristics correlated with at least one of the one or more properties or at least one characteristic of the first plurality of characteristics;
generating a correlation between the first plurality of characteristics of the first historical record and the second plurality of characteristics of the second historical record; and
transmitting, to the first client device, a result comprising the correlation between the first historical record and the second historical record.

2. The method of claim 1, wherein receiving, from the first client device, the search request comprises:
determining, based on a profile associated with the first client device, a first search element; and
performing a search of the database of historical records based on the first search element.

3. The method of claim 1, wherein receiving, from the first client device, the search request comprises:
identifying a previous search request comprising similar properties to the one or more properties;
determining, based on the previous search request, a first search element; and
performing a search of the database of historical records based on the first search element.

4. The method of claim 1, wherein processing the plurality of historical records based on the one or more properties of the search request comprises:
determining a relevance score of each of the plurality of historical records based on the one or more properties; and
removing from the result, one or more historical records comprising a low relevance score.

5. The method of claim 4, wherein determining the relevance score for each of the plurality of historical records comprises one or more of:
determining a prominence of the historical record for related search requests;
determining a presence of one or more participants within the historical record;
determining a prominence of one or more keywords within the historical record; or
determining a similarity between the historical record and a relevant historical record.

6. The method of claim 1, wherein the method further comprises:
receiving, from the first client device, a selection to further analyze the plurality of historical records based on a first characteristic of the first plurality of characteristics of the first historical record;
generating, based on the first characteristic, a second correlation between the first historical record and a third historical record, wherein the third historical record comprises a third plurality of characteristics; and
transmitting, to the first client device, the second correlation between the first historical record and the third historical record.

7. The method of claim 1, wherein the first historical record comprises one of:
a recording of one or more audio or video tracks corresponding to one or more audio or video streams exchanged during a virtual meeting; or
a record of metadata corresponding to the virtual meeting.

8. A system comprising:
a non-transitory computer-readable medium;
a communications interface; and
a processor communicatively coupled to the non-transitory computer-readable medium and the communications interface, the processor configured to execute processor-executable instructions stored in the non-transitory computer-readable medium to:
receive, from a first client device, a search request comprising one or more properties to identify a set of historical records from a database of historical records;
process a plurality of historical records based on the one or more properties of the search request;
identify a first historical record based on processing the plurality of historical records, wherein the first historical record has a first plurality of characteristics correlated with the one or more properties;
identify a second historical record based on processing the plurality of historical records, wherein the second historical record has a second plurality of characteristics correlated with at least one of the one or more properties or at least one characteristic of the first plurality of characteristics;
generate a correlation between the first plurality of characteristics of the first historical record and the second plurality of characteristics of the second historical record; and
transmit, to the first client device, a result comprising the correlation between the first historical record and the second historical record.

9. The system of claim 8, wherein the first historical record is a recording of a virtual meeting and the processor is configured to execute further processor-executable instructions stored in the non-transitory computer-readable medium to:
generate the recording of one or more audio or video tracks corresponding to one or more audio or video streams exchanged during the virtual meeting.

10. The system of claim 8, wherein the processor is configured to execute further processor-executable instructions stored in the non-transitory computer-readable medium to:
generate a record of metadata corresponding to a virtual meeting; and
add the record of the metadata to the first historical record.

11. The system of claim 10, wherein the metadata corresponding to the virtual meeting comprises one or more of:
a date and time of the virtual meeting;
a listing of the plurality of participants from the virtual meeting;
a duration of the virtual meeting; or
a topic associated with a request for the virtual meeting.

12. The system of claim 8, wherein the processor is configured to execute further processor-executable instructions stored in the non-transitory computer-readable medium to:
provide, to the first client device, a preview of a section of the first historical record, wherein the section comprises a subset of the first plurality of characteristics of the first historical record.

13. The system of claim 12, wherein the first historical record comprises a recording of a virtual meeting, and wherein the instructions to provide, to the first client device, the preview of a section of the first historical record further causes the processor to execute further processor-executable instructions stored in the non-transitory computer-readable medium to:
provide, to the first client device, a clip of one or more audio or video streams from the virtual meeting, wherein the one or more audio or video streams correspond to the subset of the first plurality of characteristics.

14. The system of claim 8, wherein the instructions to process the plurality of historical records based on the one or more properties of the search request further causes the processor to execute further processor-executable instructions stored in the non-transitory computer-readable medium to:
perform speech recognition on an audio track associated with one or more of the plurality of historical records;
generate a transcript of the audio track associated with the one or more of the plurality of historical records;
store the transcript of the audio track associated with the one or more of the plurality of historical records; and
identify, based on the transcript, the first historical record and the second historical record.

15. A non-transitory computer-readable medium comprising processor-executable instructions configured to cause one or more processors to:
receive, from a first client device, a search request comprising one or more properties to identify a set of historical records from a database of historical records comprising one or more properties;
process a plurality of historical records based on the one or more properties of the search request;
identify a first historical record based on processing the plurality of historical records, wherein the first historical record has a first plurality of characteristics correlated with the one or more properties;
identify a second historical record based on processing the plurality of historical records, wherein the second historical record has a second plurality of characteristics correlated with at least one of the one or more properties or at least one characteristic of the first plurality of characteristics;
generate a correlation between the first plurality of characteristics of the first historical record and the second plurality of characteristics of the second historical record; and
transmit, to the first client device, a result comprising the correlation between the first historical record and the second historical record.

16. The non-transitory computer-readable medium of claim 15, wherein the processor is configured to execute further processor-executable instructions stored in the non-transitory computer-readable medium to:
identify a second set of properties based on the first plurality of characteristics;
identify a third historical record based on the second set of properties, wherein the third historical record comprises a third plurality of characteristics;
generate a second correlation between the first plurality of characteristics of the first historical record and the third plurality of characteristics of the third historical record; and
transmit, to the first client device, a second result comprising the second correlation of the first historical record and the third historical record.

17. The non-transitory computer-readable medium of claim 15, wherein the processor is configured to execute further processor-executable instructions stored in the non-transitory computer-readable medium to:
receive the first historical record;
automatically process the first historical record to determine the first plurality of characteristics; and
save the first historical record and the first plurality of characteristics to the database of historical records.

18. The non-transitory computer-readable medium of claim 15, wherein the processor is configured to execute further processor-executable instructions stored in the non-transitory computer-readable medium to:
determine a section of the first historical record corresponding to the first plurality of characteristics; and
provide to the first client device, a preview of the section of the first historical record.

19. The non-transitory computer-readable medium of claim 15, wherein the processor is configured to execute further processor-executable instructions stored in the non-transitory computer-readable medium to:
receive, from the first client device, a selection of the first historical record within the result; and
provide, to the first client device, an analysis of the one or more properties for the first historical record.

20. The non-transitory computer-readable medium of claim 19, wherein the analysis of the one or more properties for the first historical record comprises a prominence of the one or more properties within the first historical record.
